(19) United States
(12) Patent Application Publication
(10) Pub. No.: US 2018/0348805 A1
(43) Pub. Date: Dec. 6, 2018

(54) Bias Current Generator

(71) Applicant: Silicon Laboratories Inc., Austin, TX (US)

(72) Inventors: Mohamed M. Elsayed, Austin, TX (US); Mohamed M. Elkholy, Austin, TX (US)

(21) Appl. No.: 15/609,644

(22) Filed: May 31, 2017

(51) Int. Cl. G05F 1/56; G05F 1/46; G05F 1/595; G05F 1/575

(52) U.S. Cl. CPC G05F 1/561; G05F 1/575; G05F 1/595; G05F 1/468

(57) ABSTRACT

Embodiments of bias current generator circuits are provided herein for generating stable bias currents. In one embodiment, a bias current generator circuit may include a voltage-to-current generating circuit, an integrate and hold circuit, an amplifier circuit and a plurality of output branches. The voltage-to-current generating circuit may supply a first current to a first node of the bias current generator circuit. The integrate and hold circuit may receive a second current, which is equal to a difference between the first current and a reference current, from the first node and may generate a first voltage in response thereto. The amplifier circuit may receive the first voltage generated by the integrate and hold circuit, and may generate a second voltage in response to the first voltage. The plurality of output branches may receive the second voltage, and may generate a plurality of bias currents in response thereto.

### BACKGROUND

### 1. Field of the Disclosure

This disclosure relates to bias current generator circuits and, more particularly, to bias current generator circuits coupled to multiple client circuits.

### 2. Description of the Relevant Art

The following descriptions and examples are provided as background only and are intended to reveal information that is believed to be of possible relevance to the present invention. No admission is necessarily intended, or should be construed, that any of the following information constitutes prior art impacting the patentable character of the subjected matter claimed herein.

Bias current generator circuits are often used to generate and supply bias currents to one or more sub-circuits (or “clients”) of an integrated circuit or electronic device. Current mirrors are commonly used in conventional bias current generator circuits. If the transistors included within the current mirror are well matched, the current flowing through one transistor is copied or “mirrored” to the current path flowing through the other transistor.

FIG. 1 illustrates one example of a conventional bias current generator circuit 10 including a current mirror circuit formed from two (or more) P-channel Metal Oxide Semiconductor (PMOS) transistors having commonly connected gate and source terminals. The source terminals of the PMOS transistors P1 and P2 are coupled to receive a supply voltage (e.g., VDD). The drain terminal of the diode-connected transistor P1in the current mirror input branch is coupled to receive a reference current (I_{ref}) from a reference current source 20, which is coupled between the drain terminal of transistor P1 and ground. The reference current source 20 may be implemented in a variety of different ways including, but not limited to, a resistor, another current mirror, and/or other circuitry. The drain terminal of the transistor P2 in the current mirror output branch is coupled to supply at least one bias current (I_{b}) to a sub-circuit (or “client”) of an integrated circuit or electronic device. In some cases, the current mirror circuit may include a plurality (N) of output branches, each with its own transistor P2, for supplying a plurality of similar (or dissimilar) bias currents (I_{b1 . . . bN}) to multiple sub-circuits or clients.

The current mirror circuit 10 shown in FIG. 1 also includes a first switch (S1), a second switch (S2) and a hold capacitor (C_{hold}). The first switch (S1) is coupled between reference current source 20 and the drain terminal of diode-connected transistor P1, the second switch (S2) is coupled between the gate terminals of transistors P1 and P2, and the hold capacitor (C_{hold}) is coupled between the supply voltage and the gate terminal of output transistor(s) P2. When switches S1 and S2 are closed, the reference current source 20 supplies a reference current (I_{ref}) to bias current generator 10, and the diode-connected transistor P1 generates a feedback current (I_{fb}) in response thereto. The reference and feedback currents are subtracted at node n1, and the difference between the two currents (ΔI=I_{fb}−I_{ref}) is integrated across the hold capacitor (C_{hold}). The voltage across the hold capacitor drives the gate terminals of transistors P1 and P2, and the feedback loop becomes stable when I_{fb}=I_{ref}.

In the example current mirror circuit 10 shown in FIG. 1, switches S1 and S2 are periodically opened to reduce power consumption in the bias current generator and the reference current source 20 (which may be powered down when the switches S1 and S2 are open). When switches S1 and S2 are open, the voltage across the capacitor (C_{hold}) continues to drive the gate terminal(s) of the output transistor(s) P2 to provide bias current(s) to the client(s). In some cases, the voltage across the capacitor may be regularly refreshed by closing switches S1 and S2. Refresh may be needed, for example, to compensate for leakage charges from the capacitor.

A problem arises in bias current generator circuit 10 when multiple clients are coupled to receive bias currents, and one client generates a disturbance ΔVₒᵤₜ at the output terminal of the bias current generator circuit (e.g., the drain terminal of output transistor P2). The disturbance can be relatively large if the client turns its bias current OFF/ON. When a voltage disturbance occurs at any output terminal, the gate-to-drain capacitance (C_{gd}) of the output transistor P2 supplying current to the client suffers a voltage change of ΔVₒᵤₜ. In some cases, the C_{gd} voltage swing across the affected output transistor P2 may be as much as 3V in the example circuit shown in FIG. 1. This voltage change introduces an error that can be approximated as ΔVₒᵤₜ*C_{gd}/C_{hold} (i.e., a kickback voltage, V_{kickback}) in the voltage held across the capacitor (C_{hold}), which in turn, introduces an error in the generated bias current. In one example, the error in the generated bias current may be approximately equal to:

$$\frac{Δ I}{I} = \frac{{g}_{mp}}{I} * {V}_{kickback} \qquad EQ . 1$$

In EQ. 1, gₘₚ is the transconductance of output transistor P2, I is the bias current, V_{kickback} is the kickback voltage across the capacitor (C_{hold}), and ΔI is the error generated in the bias current as a result of V_{kickback}. When multiple output transistors P2 are included for supplying bias currents to multiple clients, the kickback voltage generated when one client turns its bias current OFF/ON is propagated across all output transistors P2, thereby introducing an error in all bias currents generated thereby.

FIG. 2 illustrates another example of a conventional bias current generator circuit 30, which attempts to reduce the C_{gd} voltage swing across the affected output transistor P2. For this example, the C_{gd} voltage swing is reduced by adding cascode transistors (including, e.g., PMOS transistors P3 and P4) with the first current mirror circuit; coupling a second capacitor (C_{cas}) between the supply voltage (VDD) and the gate terminals of transistors P3 and P4; and coupling a third switch (S3) between the gate terminals of transistors P3 and P4. As in the previous example shown in FIG. 1, power consumption can be reduced after voltages are developed across the capacitors (C_{hold} and C_{cas}) by opening switches S1, S2 and S3. When the switches are opened, the voltages developed across the first and second capacitors (C_{hold} and C_{cas}) are held and used to drive the gate terminals of output transistors P2 and P4, respectively. As in the previous example, the voltages held across the first and second capacitors (G_{hold} and C_{cas}) may be regularly refreshed by powering up the reference current source and closing switches S1, S2 and S3 to compensate for leakage currents in the switches.

Although the addition of cascode transistors P3 and P4 and cascode capacitor C_{cas} may help to reduce the C_{gd} voltage swing (e.g., to about 250 mV) across the affected output transistor P2, bias current generator circuit 30 still suffers from voltage kickback. When one client turns its bias current ON/OFF, for example, the voltage held across the cascode capacitor C_{cas} suffers a kickback voltage of ΔVₒᵤₜ*C_{gd}_{_}_{cas}/C_{cas}. This kickback voltage couples to the gate of the affected output transistor P2 through the gate-to-drain capacitance (C_{gd}) of the affected output transistor P2 to result in a total kickback voltage of:

$${V}_{kickback} = \{ Δ {V}_{out} * \frac{{C}_{{gd}_{cas}}}{{C}_{cas}} * ( N - 1 ) + {V}_{ds} \} \frac{{C}_{gd}}{{C}_{hold}} . \qquad EQ . 2$$

In EQ. 2, C_{hold} and C_{cas} are the total capacitances connected to the gate terminals of the output transistor(s) P2 and cascode transistor P4, respectively, including device parasitic capacitances; C_{gd} and C_{gdcas} are the gate-to-drain capacitances of transistors P2 and P4; N is the number of output current branches; and V_{ds} is the drain-to-source voltage of output transistor P2. As noted above, the kickback voltage shown in EQ. 2 introduces an error in the bias currents, according to EQ. 1. The error shown in EQ. 1 affects the bias currents generated in all output current branches, until switches S1, S2 and S3 are closed to refresh the voltages held across capacitors C_{hold} and C_{cas}.

### SUMMARY

The present disclosure provides various embodiments of improved bias current generator circuits and related methods that are used to generate stable bias currents, while reducing power consumption of the bias current generator circuit and a reference current source circuit coupled thereto. The following description of various embodiments of bias current generator circuits and methods for generating bias currents represent example embodiments and is not to be construed in any way as limiting the subject matter of the appended claims.

According to one embodiment, a bias current generator circuit coupled to receive a reference current from a reference current source, may generally include a voltage-to-current generating circuit, an integrate and hold circuit, an amplifier circuit and a plurality of output branches. The voltage-to-current generating circuit may generally be coupled to supply a first current to a first node of the bias current generator circuit. The integrate and hold circuit may generally be coupled to the first node for receiving a second current, which is equal to a difference between the first current and the reference current, and may be configured to generate a first voltage in response to the second current. The amplifier circuit may generally be coupled to receive the first voltage generated by the integrate and hold circuit, and may be configured to generate a second voltage in response to the first voltage. The plurality of output branches may generally be coupled to receive the second voltage from the amplifier circuit and may be configured to generate a plurality of bias currents in response thereto.

Embodiments of the bias generator circuit described herein may generally include at least one switch. In some embodiments, a first switch may be coupled between the reference current source and the first node for connecting and disconnecting the reference current source to and from the first node. In other embodiments, the first switch may alternatively be included within the reference current source, or may be omitted if reference current source can be powered down by other means.

In some embodiments, a second switch may be coupled between the first node and a second node of the bias current generator circuit. The second node may be coupled to an input of the amplifier circuit. When the second switch is closed and the reference current source is connected to the bias current generator circuit for supplying the reference current to the first node, the first node may be connected to the second node for supplying the second current to the integrate and hold circuit, which may use the second current to generate the first voltage. When the second switch is opened and the reference current source is disconnected from the bias current generator circuit, the first node is disconnected from the second node, and the first voltage generated by the integrate and hold circuit is supplied to the input of the amplifier circuit for generating the second voltage.

According to a first embodiment of the bias current generator circuit disclosed herein, the voltage-to-current generating circuit may include a first n-channel Metal Oxide Semiconductor (NMOS) transistor having a drain terminal coupled to the first node, a source terminal coupled to a ground potential, and a gate terminal coupled to the second node and to the input of the amplifier circuit. However, the voltage-to-current generating circuit is not limited to including only the first NMOS transistor. In other embodiments, a cascode transistor may be coupled in series with the first NMOS transistor, such that the drain terminal of the first NMOS transistor is coupled to the source terminal of the cascode transistor, and the drain terminal of the cascode transistor is coupled to the first node.

In some embodiments, the integrate and hold circuit may include a capacitor, the amplifier circuit may be implemented as a single-ended amplifier, and the plurality of output branches may include a plurality of cascoded PMOS transistors. The capacitor may be coupled in parallel with the first NMOS transistor between the second node and the ground potential, and the first voltage may be generated across the capacitor in response to the second current.

In some embodiments, the single-ended amplifier circuit may include a first p-channel MOS (PMOS) transistor coupled in series with a second NMOS transistor between a supply voltage and the ground potential. In such embodiments, a gate terminal of the first PMOS transistor may be coupled to a drain terminal of the first PMOS transistor. In other embodiments, the single-ended amplifier circuit may include a one or more PMOS cascode transistors coupled in series with the second NMOS transistor between the supply voltage and the ground potential. In such embodiments, the gate terminal of the uppermost cascoded PMOS transistor may be coupled to the drain terminal of the lowermost cascoded PMOS transistor. In either of these embodiments, a gate terminal of the second NMOS transistor may be coupled to the second node and to the gate terminal of the first NMOS transistor. In the output branches, the plurality of cascoded PMOS transistors may each have a source terminal coupled to the supply voltage and a gate terminal coupled to the gate terminal of the first PMOS transistor (or alternatively the uppermost cascoded PMOS transistor).

According to a second embodiment of the bias current generator circuit disclosed herein, the voltage-to-current generating circuit may include a first PMOS transistor having a source terminal coupled to a supply voltage, and a drain terminal coupled to the first node. However, the voltage-to-current generating circuit is not limited to including only the first PMOS transistor. In other embodiments, a cascode transistor may be coupled in series with the first PMOS transistor, such that the drain terminal of the first PMOS transistor is coupled to the source terminal of the cascode transistor, and the drain terminal of the cascode transistor is coupled to the first node.

In some embodiments, the integrate and hold circuit may include a capacitor, the amplifier circuit may be implemented as a unity gain amplifier, and the plurality of output branches may include a plurality of PMOS transistors. The capacitor may be coupled between the supply voltage and the second node, and the first voltage may be generated across the capacitor in response to the second current. The unity gain amplifier may have a first input coupled to the second node. In the output branches, the PMOS transistors may each have a source terminal coupled to the supply voltage and a gate terminal coupled to an output of the amplifier circuit. In some embodiments, a gate terminal of the first PMOS transistor within the voltage-to-current generating circuit may be coupled to the second node. In other embodiments, a gate terminal of the first PMOS transistor within the voltage-to-current generating circuit may be coupled to the output of the amplifier circuit and to the gate terminals of the plurality of PMOS transistors.

According to another embodiment, a method is provided herein for generating bias currents in a bias current generator circuit including at least one switch, a capacitor, an amplifier circuit and a plurality of output branches. In some embodiments, the method may include closing the at least one switch to: supply a current to the capacitor; supply a first voltage to the amplifier circuit; and supply a second voltage to the plurality of output branches to generate a plurality of bias currents. While the at least one switch is closed, the method may further include: generating the first voltage across the capacitor in response to the current; providing the first voltage to the amplifier circuit, which uses the first voltage to generate the second voltage; and supplying the second voltage to the plurality of output branches to generate the plurality of bias currents.

In addition, the method may include opening the at least one switch to decouple the current from the capacitor. While the at least one switch is open, the method may further include: continuing to supply the first voltage to the amplifier circuit; continuing to supply the second voltage to the plurality of output branches to generate the plurality of bias currents; and correcting an error, which occurs when a client coupled to receive one of the plurality of bias currents disturbs the second voltage, to ensure that the plurality of bias currents remain stable. In some embodiments, the step of correcting an error may include forcing the second voltage to be proportional to the first voltage via the amplifier circuit. In other embodiments, the step of correcting an error may include forcing the second voltage to return back to a previous value of the second voltage before the second voltage was disturbed by the client.

According to an alternative embodiment, a bias current generator circuit is provided herein, which is coupled to receive a reference current from a reference current source at a first node. In the alternative embodiment, the bias current generator circuit may generally include a current mirror input branch coupled to receive the reference current, and a plurality of current mirror output branches coupled to the current mirror input branch. In some embodiments, the current mirror input branch may include a diode-connected transistor, which is configured to generate a feedback current equal to the reference current. In such embodiments, the plurality of current mirror output branches may be configured to generate a plurality of bias currents, which are substantially equal to the feedback current. In some embodiments, the plurality of current mirror output branches may each include: a transistor coupled between a supply voltage and an output of the bias current generator circuit; and a capacitor coupled in parallel with the transistor between the supply voltage and an input terminal of the transistor. In some embodiments, the plurality of current mirror output branches may each further include a switch, which is coupled between an input terminal of the diode-connected transistor in the current mirror input branch and the input terminal of the transistor in a respective current mirror output branch.

### BRIEF DESCRIPTION OF THE DRAWINGS

Other objects and advantages of the invention will become apparent upon reading the following detailed description and upon reference to the accompanying drawings.

FIG. 1 (Prior Art) is a block diagram illustrating one embodiment of a conventional bias current generator circuit;

FIG. 2 (Prior Art) is a block diagram illustrating another embodiment of a conventional bias current generator circuit;

FIG. 3 is a block diagram illustrating a bias current generator circuit, according to one embodiment of the present disclosure;

FIG. 4 is a circuit diagram illustrating one embodiment of a reference current source that may be used to supply a reference current to the bias current generator circuit shown in FIG. 3;

FIG. 5 is a circuit diagram illustrating another embodiment of a reference current source that may be used to supply a reference current to the bias current generator circuit shown in FIG. 3;

FIG. 6 is a circuit diagram of the bias current generator circuit shown in FIG. 3, according to a first embodiment;

FIG. 7 is a circuit diagram of the bias current generator circuit shown in FIG. 6 illustrating one manner in which the amplifier circuit of FIG. 6 may be implemented;

FIG. 8 is a circuit diagram of the bias current generator circuit shown in FIG. 3, according to a second embodiment;

FIG. 9 is a circuit diagram of the bias current generator circuit shown in FIG. 3, according to a third embodiment;

FIG. 10 is a circuit diagram illustrating one embodiment of the amplifier circuit included within the bias current generator circuits shown in FIGS. 8 and 9;

FIG. 11 is a flow chart diagram illustrating one embodiment of a method for generating bias currents in a bias current generator circuit; and

FIG. 12 is a circuit diagram illustrating a bias current generator circuit according to another embodiment of the present disclosure.

While the present disclosure is susceptible to various modifications and alternative forms, specific embodiments thereof are shown by way of example in the drawings and will herein be described in detail. It should be understood, however, that the drawings and detailed description thereto are not intended to limit the present disclosure to the particular form disclosed, but on the contrary, the intention is to cover all modifications, equivalents and alternatives falling within the spirit and scope of the present disclosure as defined by the appended claims.

### DETAILED DESCRIPTION OF THE PREFERRED EMBODIMENTS

Generally speaking, the present disclosure provides various embodiments of an improved bias current generator circuit and related methods for generating stable bias currents, while reducing power consumption of the bias current generator circuit and a reference current source circuit coupled thereto. Although the bias current generator circuit embodiments presented herein could each be used for generating a single bias current, they are illustrated and described herein for generating a plurality (N) of bias currents to be supplied to a plurality of sub-circuits (or “clients) of an integrated circuit or electronic device. Like conventional bias generator circuits, the bias current generator circuit embodiments described herein may reduce power consumption by turning off a reference current source, and using a voltage developed across a capacitor (or another “integrate and hold circuit”) to drive the output branches of the bias current generator circuit. Unlike conventional current mirror circuits, the bias current generator circuit embodiments described herein are configured to compensate or correct the voltage kickback that may occur when one client disturbs the output node of the bias current generator circuit, for example, by turning its respective bias current OFF/ON. As such, the bias current generator circuit embodiments described herein improve upon conventional current mirror circuits by providing stable bias currents to all clients, regardless of client operating state.

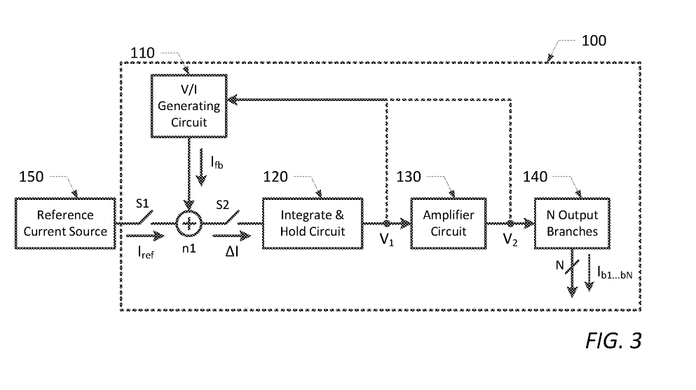

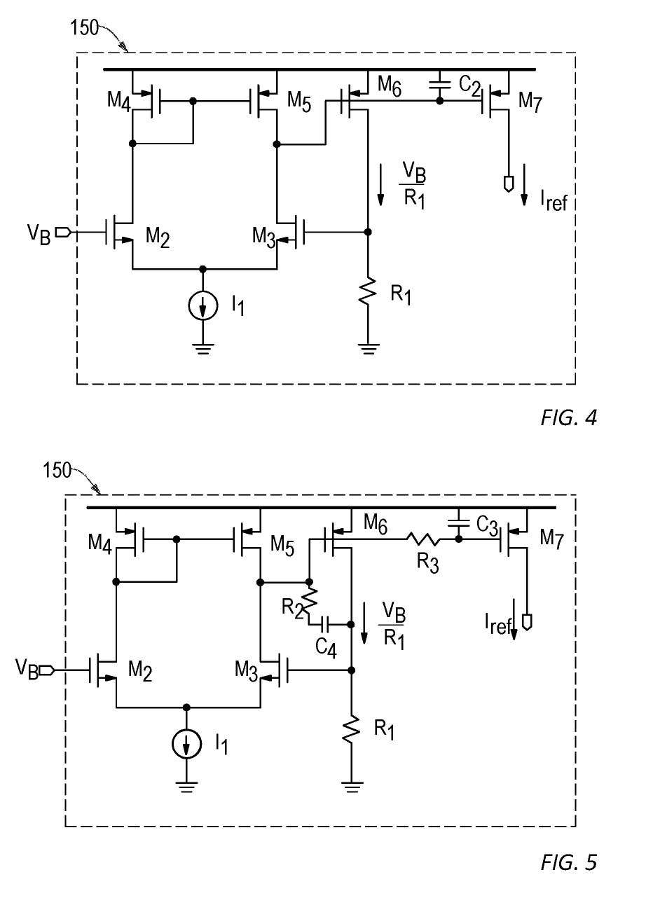

FIG. 3 is a block diagram illustrating one embodiment of a bias current generator circuit 100 including a voltage-to-current generating circuit 110, an integrate and hold circuit 120, an amplifier circuit 130 and a plurality of output branches 140. In the general embodiment shown in FIG. 3, bias current generator circuit 100 is coupled to receive a reference current (I_{ref}) from a reference current source 150, and configured to generate a plurality of bias currents (I_{b1 . . . bN}). Although substantially any current source may be used (such as, e.g., a resistor, a current mirror, etc.), various examples of suitable reference current sources 150 are shown in FIGS. 4-5 and discussed in more detail below.

Embodiments of the bias current generator circuit disclosed herein may also include at least one switch for connecting/disconnecting the reference current source 150 to/from the bias current generator circuit 100. As described in more detail below, the at least one switch may be initially closed to connect the reference current source 150 to the bias generator circuit 100 for supplying a reference current (I_{ref}) thereto. When a reference current is applied to the bias current generator circuit 100, integrate and hold circuit 120 generates a first voltage (V₁), which is supplied to amplifier circuit 130 for driving the plurality of output branches 140 to generate the plurality of bias currents (I_{b1 . . . bN}). To reduce power consumption, the at least one switch may be opened to disconnect and disable the reference current source 150 from the bias current generator circuit 100 sometime after the first voltage is generated. While the at least one switch is open, integrate and hold circuit 120 continues to supply the first voltage to amplifier circuit 130 for driving the plurality of output branches 140 to generate the plurality of bias currents.

In the particular block diagram shown in FIG. 3, a pair of switches (S1 and S2) is used to connect/disconnect the reference current source 150 to/from the bias generator circuit 100. In particular, a first switch (S1) is coupled between the reference current source 150 and a first node (n1) of the bias current generator circuit 100, and a second switch (S2) is coupled between the first node and the integrate and hold circuit 120. The first and second switches S1 and S2 may be implemented in any known manner (e.g., PMOS transistors, NMOS transistors, and/or other switch circuitry), and thus, are illustrated generically in the Drawings.

Although two switches are shown in the embodiment of FIG. 3, it is noted that a fewer or greater number of switches may be used in alternative embodiments to connect/disconnect the reference current source 150 to/from the bias current generator circuit 100. In one alternative embodiment contemplated herein, switch S1 may be embedded within the reference current source 150 instead of the bias current generator circuit 100. In another alternative embodiment contemplated herein, switch S1 may be eliminated if reference current source 150 can be powered down by other means.

When the first switch (S1) is closed, reference current source 150 is coupled to supply a reference current (I_{ref}), and voltage-to-current generating circuit 110 is coupled to supply a first current (I_{fb}), to the first node (n1) of the bias current generator circuit 100. When the second switch (S2) is closed, a second current (ΔI) equal to a difference between the first current (I_{fb}) and the reference current (I_{ref}) is supplied to the integrate and hold circuit 120, which uses the second current to generate the first voltage (V₁). In one embodiment, the first and second switches may be closed sequentially, one after the other, with or without a time lag in between to minimize any voltage disturbances across the integrate and hold circuit 120. In particular, switch S1 may be closed to enable the voltage at the first node (n1) to settle before switch S2 is closed.

In the embodiment shown in FIG. 3, the first voltage (V₁) generated by the integrate and hold circuit 120 is supplied to amplifier circuit 130 to generate a second voltage (V₂), which in turn, is supplied to the plurality of output branches 140 to generate the plurality of bias currents (I_{b1 . . . bN}). Substantially any number (N) of output branches 140 may be included within bias current generator circuit 100 to generate the same number (N) of bias currents (I_{b1 . . . bN}). In some embodiments, the number (N) may be an integer value greater than or equal to 1.

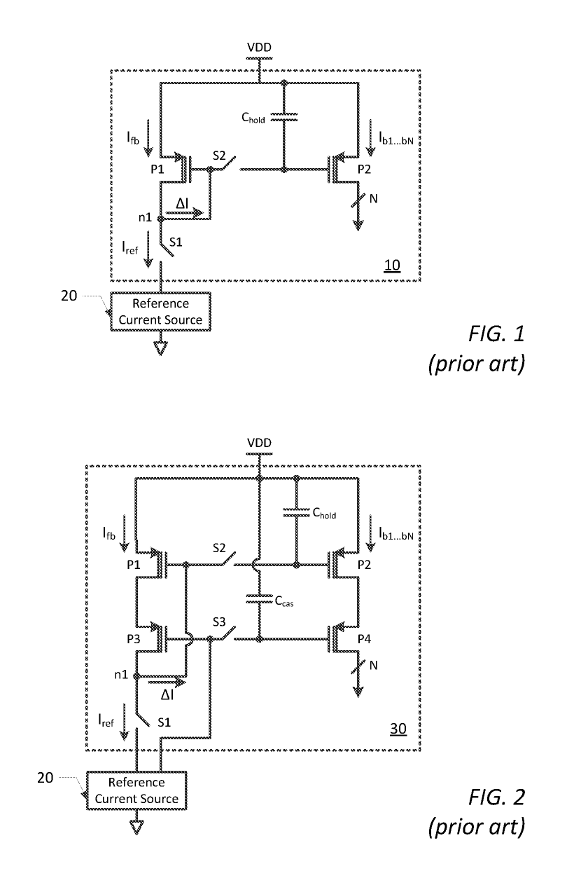

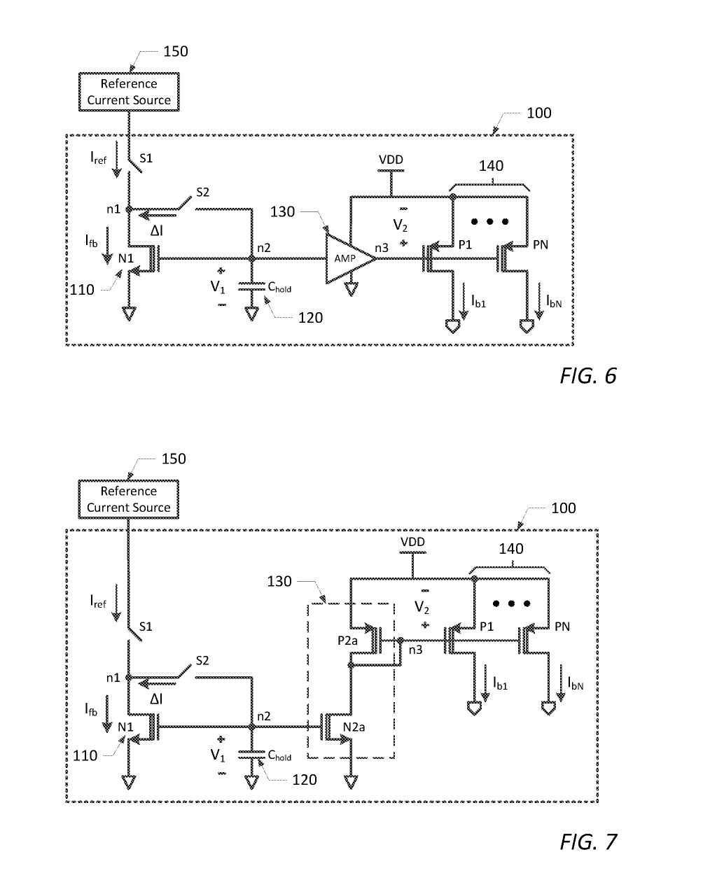

As described in more detail below, amplifier circuit 130 may be included to eliminate or mitigate adverse effects that may occur when a sub-circuit (or “client”) coupled to one of the output branches 140 disturbs the output node of the bias current generator circuit for any reason. In one example, a client connected to an output node of the bias current generator circuit may disturb the voltage at the output node by turning its respective bias current OFF/ON. It is noted, however, that client created voltage disturbances are not limited to such activity, and may arise from voltage ripples in the client module or other activity. Unlike the conventional current mirror circuits 10 and 30 shown in FIGS. 1 and 2, amplifier circuit 130 isolates the first voltage (V₁) generated by the integrate and hold circuit 120 from the second voltage (V₂) used to drive the plurality of output branches 140, thereby preventing or significantly reducing voltage kickback from affecting the first voltage when one of the connected clients disturbs the voltage at its output node. If one or more of the output branches 140 suffers a voltage change, amplifier circuit 130 compensates for such voltage change to ensure that stable bias currents are generated in all output branches. Amplifier circuit 130 may be implemented in a variety of different ways, including both single-ended and differential circuit embodiments, and may be connected in a variety of different ways. Various embodiments that use different amplifier circuits are shown in FIGS. 6-10 and discussed in more detail below.

As shown in FIG. 3, a voltage generated by the bias current generator circuit 100 may drive the voltage-to-current generating circuit 110 to generate a first current (I_{fb}) equal to the reference current (I_{ref}) when the first and second switches S1 and S2 are closed. In some embodiments (see, e.g., FIGS. 6-8), the first voltage (V₁) generated by integrate and hold circuit 120 may be used to drive the voltage-to-current generating circuit 110 when the first and second switches are closed. In other embodiments (see, e.g., FIG. 9), the second voltage (V₂) generated by amplifier circuit 130 may be used to drive the voltage-to-current generating circuit 110 when the first and second switches are closed.

In order to conserve power, the first and second switches S1 and S2 may be open for a majority of the time, while the integrate and hold circuit 120 holds the voltage across its terminals. In some embodiments, the first and second switches S1 and S2 may be opened concurrently. In other embodiments, the first and second switches S1 and S2 may be opened sequentially with or without a time lag in between.

In some embodiments, leakage charges from the hold capacitor, either through the first and second switches S1 and S2 or any other leakage path, may cause the first voltage (V₁) generated by the integrate and hold circuit 120 to drift over time. In such embodiments, the first and second switches S1 and S2 may be temporarily closed to “refresh” the first voltage generated by the integrate and hold circuit 120. To refresh the first voltage, the reference current source 150 may be powered up and the first switch S1 may be closed. After a first period of time, which allows the reference current source to settle and the first node (n1) to reach steady state value, the second switch S2 is closed to couple the first node (n1) to the second node (n2) and the integrate and hold circuit 120. Once the second switch S2 is closed, the voltage across the integrate and hold circuit 120 is refreshed and the voltage drift is corrected. After another period of time, which enables the voltage at the second node (n2) to settle, the first and second switches S1 and S2 may be reopened to again disconnect the first node (n1) from the second node (n2).

In some embodiments, a hardware and/or software control unit or circuit may be coupled to control the opening and closing of the first and second switches. In some embodiments, the hardware and/or software control unit or circuit may be configured (or programmed) to open and close the switches at a fixed rate (e.g., a “refresh rate”) after the switches are initially closed. In one embodiment, the fixed rate may range between about 10 Hz and about 10000 Hz; however, such rate may vary depending on the level of leakage charges from the integrate and hold circuit 120.

As noted above, substantially any reference current source 150 may be used to generate and supply a reference current (I_{ref}) to the bias current generator circuit 100 shown in FIG. 3. FIG. 4 is a circuit diagram illustrating one example of a reference current source 150 that may be used to generate and supply a reference current (I_{ref}) to the bias current generator circuit of FIG. 3. FIG. 5 is a circuit diagram illustrating another example of a suitable reference current source 150.

In the exemplary embodiments shown in FIGS. 4 and 5, a bias voltage (V_{B}) is supplied to a gate terminal of an NMOS transistor (M₂), the source terminal of which is coupled to a current source (I₁) coupled to ground. The drain terminal of NMOS transistor M₂ is coupled to the drain terminal of a diode-connected PMOS transistor (M₄), the source terminal of which is coupled to a supply voltage (e.g., VDD). The gate terminal of diode-connected PMOS transistor M₄ is coupled to the gate terminal of PMOS transistor (M₅) in a current mirror configuration. PMOS transistor M₅ has a source terminal coupled to the supply voltage and a drain terminal coupled to the drain terminal of NMOS transistor (M₃), the source terminal of which is coupled to the current source (I₁) and the source terminal of NMOS transistor M₂.

When the bias voltage (V_{B}) is applied to the gate of NMOS transistor M₂, a current flowing through transistors M₄ and M₂ is mirrored to a current path through transistors M₅ and M₃. If transistors M₄/M₂ and M₅/M₃ have the same current density, a substantially identical copy of the current through transistors M₄ and M₂ is mirrored to the current path through transistors M₅ and M₃. The mirrored current causes a gate-to-source voltage to be applied to the gate terminal of a PMOS transistor (M₆) having a source terminal coupled to the supply voltage and a drain terminal coupled to a resistor (R₁), which is coupled to ground. Upon receiving the gate-to-source voltage, a current substantially equal to V_{B}/R₁ is generated through the current path of PMOS transistor M₆.

In the reference current source 150 embodiments shown in FIGS. 4 and 5, the current (V_{B}/R₁) through PMOS transistor M₆ is mirrored to an output PMOS transistor (M₇) to generate a reference current (I_{ref}). A capacitor (e.g., C₂ in FIG. 4 and C₃ in FIG. 5) is coupled between the supply voltage and the commonly connected gate terminals of PMOS transistors M₆ and M₇. Although similar, the reference current source 150 shown in FIG. 5 differs from the embodiment shown in FIG. 4 by coupling an RC network (comprising resistor R₂ and capacitor C₄) across the gate and drain terminals of PMOS transistors M₆ and adding another resistor (R₃) between the gate terminals of PMOS transistors M₆ and M₇ for improved noise immunity. In some cases, the reference current source 150 embodiment shown in FIG. 4 may be preferred when immunity to power supply noise is a concern. However, the reference current source 150 embodiment shown in FIG. 5 is more area efficient, and may be preferred in other cases when board space is a concern.

FIGS. 6-9 provide exemplary circuit diagrams for the bias current generator circuit 100 shown in block diagram form in FIG. 3. As in the generic block diagram of FIG. 3, the bias current generator circuits 100 shown in FIGS. 6-9 may generally include a first switch S1, a voltage-to-current generating circuit 110, a second switch S2, an integrate and hold circuit 120, an amplifier circuit 130 and a plurality of output branches 140. In addition, the bias current generator circuits 100 shown in FIGS. 6-9 may be coupled to source or sink a reference current (I_{ref}) from a reference current source 150, and may be configured to generate a plurality of bias currents (I_{b1 . . . bN}). Although substantially any reference current source may be used (such as, e.g., a resistor, a current mirror, etc.), one of the reference current sources shown in FIGS. 4-5 and discussed above may be used, in some embodiments, to provide a reference current to one or more of the bias current generator circuits shown in FIGS. 6-9.

In FIGS. 6-9, the voltage-to-current generating circuit 110, amplifier circuit 130 and output branches 140 of bias current generator circuit 100 are implemented with Complementary Metal Oxide Semiconductor (CMOS) transistor technology. As such, these components are described and illustrated in FIGS. 6-9 as including NMOS and/or PMOS transistors having gate, drain and source terminals. However, the bias current generator circuit embodiments shown in FIGS. 6-9 are not strictly limited to CMOS technology, and may be implemented with alternative process technologies (e.g., silicon-over-insulator) in other embodiments. A skilled artisan would understand how the description below may change when an alternative process technology is used to implement bias current generator circuit 100.

In each of the embodiments shown in FIGS. 6-9, a pair of switches (S1 and S2) is used to connect/disconnect the reference current source 150 to/from the bias generator circuit 100 and to connect/disconnect the integrate and hold circuit 120 to/from the voltage-to-current generating circuit 110. In particular, a first switch (S1) is coupled between reference current source 150 and a first node (n1) of the bias current generator circuit 100. In addition, a second switch (S2) is coupled between the first node (n1) and a second node (n2), which is coupled to an input of amplifier circuit 130. When the first and second switches S1 and S2 are closed, reference current source 150 is connected to the bias current generator circuit 100 for supplying a reference current (I_{ref}) to the first node (n1), and the first node is connected to the second node (n2) for supplying a second current (ΔI) to the second node (n2). When the first and second switches S1 and S2 are opened, reference current source 150 is disconnected from the bias current generator circuit 100, and the first node (n1) is disconnected from the second node (n2).

FIG. 6 is a circuit diagram of the bias current generator circuit 100 shown in FIG. 3, according to a first embodiment. In embodiment shown in FIG. 6, voltage-to-current generating circuit 110 includes an NMOS transistor N1 having a drain terminal coupled to the first node (n1), a source terminal coupled to a ground potential, and a gate terminal coupled to the second node (n2) and to the input of amplifier circuit 130. However, the voltage-to-current generating circuit 110 shown in FIG. 6 is not limited to including only NMOS transistor N1. In other embodiments (not shown), a cascode transistor may be coupled in series with the NMOS transistor N1, such that the drain terminal of NMOS transistor N1 is coupled to the source terminal of the cascode transistor, and the drain terminal of the cascode transistor is coupled to the first node (n1).

In the embodiment shown in FIG. 6, integrate and hold circuit 120 includes a capacitor (Chola), which is coupled between the second node (n2) and ground. When switches S1 and S2 are closed, reference current source 150 supplies a reference current (I_{ref}) to the bias current generator circuit, which induces a feedback current (I_{fb}) through NMOS transistor N1. The reference and feedback currents are subtracted at the first node (n1), and a difference between the two currents (ΔI=I_{fb}−I_{ref}) is integrated across the capacitor (C_{hold}) to generate a first voltage (V₁) at the second node (n2). The first voltage (V₁) is fed back to the gate terminal of NMOS transistor N1, and the feedback loop becomes stable when I_{fb}=I_{ref}. The first voltage (V₁) is also supplied to the input of amplifier circuit 130.

In the embodiment shown in FIG. 6, amplifier circuit 130 is a single-ended amplifier having an input coupled to the second node (n2), an output coupled to a third node (n3) and control terminals coupled between the supply voltage and ground potential. The gain of amplifier circuit 130 may be greater than, equal to or less than 1. The input of amplifier circuit 130 (i.e., the first voltage, V₁, generated across the capacitor) is coupled to the gate terminal of the NMOS transistor (N1) in the voltage-to-current generating circuit 110. The output of amplifier circuit 130 is coupled to drive the gate terminals of the PMOS transistors (P1 . . . PN) in the output branches 140. As noted above, substantially any number (N) of PMOS transistors may be included within the output branches 140 for generating the same number (N) of bias currents (I_{b1 . . . bN}). The single-ended amplifier circuit 130 shown in FIG. 6 may be implemented in a variety of different ways, one of which is shown in FIG. 7 and described in more detail below.

FIG. 7 is a circuit diagram of the bias current generator circuit 100 shown in FIG. 6 illustrating one manner in which the single-ended amplifier circuit 130 may be implemented. In the example embodiment shown in FIG. 7, single-ended amplifier circuit 130 includes a PMOS transistor (P2a) and an NMOS transistor (N2a) between the supply voltage and ground potential. A gate terminal of NMOS transistor N2a is coupled to the second node (n2) for receiving the first voltage (V₁), which is generated and held across capacitor C_{hold}. The drain terminal of NMOS transistor N2a is coupled to the gate and drain terminals of diode-connected PMOS transistor P2a for generating a second voltage (V₂), which is proportional to the first voltage (V₁), at the output of the amplifier circuit (i.e., at node n3). The gate terminal of the diode-connected PMOS transistor P2a is coupled to the gate terminals of the PMOS transistors (P1 . . . PN) in the output branches 140 for supplying the second voltage (V₂) thereto.

The amplifier circuit 130 shown in FIGS. 6 and 7 isolates the first voltage (V₁) generated across the capacitor C_{hold} from the second voltage (V₂), which is used to drive the output branches 140. When one of the connected clients turns its bias current OFF/ON, a corresponding one of the PMOS transistors (P1 . . . PN) in output branches 140 will suffer a voltage change (e.g., ΔVₒᵤₜ) at the output node (drain terminal of the output transistor). However, amplifier circuit 130 compensates for this voltage error by forcing the second voltage (V₂) to be proportional to the first voltage (V₁), which is generated and held across the capacitor C_{hold}. By isolating the first voltage (V₁) from the second voltage (V₂), the amplifier circuit 130 shown in FIGS. 6 and 7 prevents or significantly inhibits voltage kickback from affecting the voltage across the capacitor when one (or more) of the connected clients turns its bias current OFF/ON (or disturbs the output node voltage for any other reason) and ensures that stable bias currents (I_{b1 . . . bN}) are generated in all output branches 140.

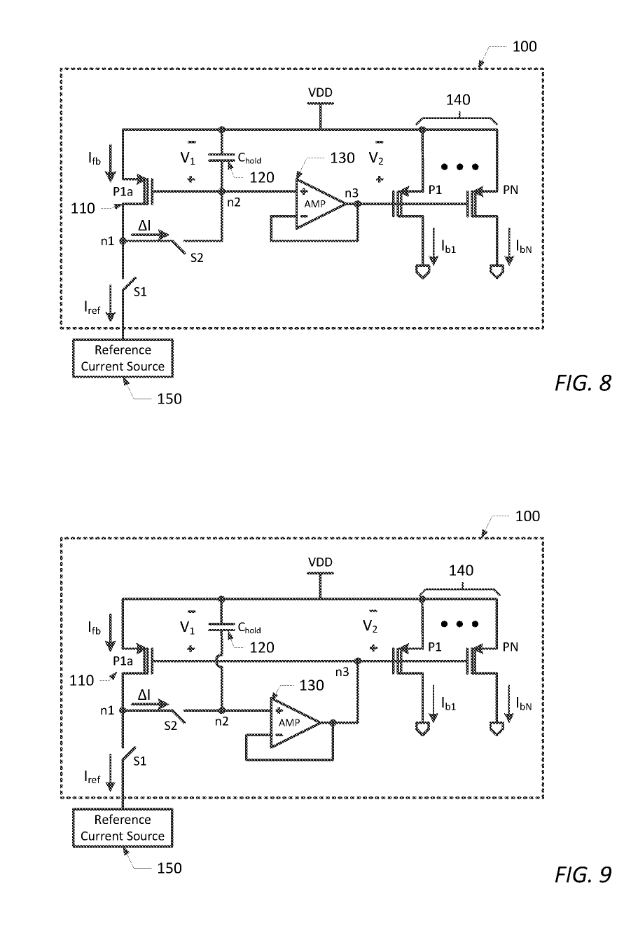

Although stable bias currents are generated in the embodiments shown in FIGS. 6 and 7, regardless of client operating state, the amplifier circuit 130 depicted in FIG. 7 may consume a relatively large amount of current, since diode-connected PMOS transistor P2a is always on. In order to reduce current consumption, alternative implementations of bias current generator circuits are shown in FIGS. 8 and 9.

FIGS. 8 and 9 provide circuit diagrams of the bias current generator circuit 100 shown in FIG. 3, according to second and third embodiments of the present disclosure. In the embodiments shown in FIGS. 8 and 9, the voltage-to-current generating circuit 110 includes a PMOS transistor (P1a) having a source terminal coupled to a supply voltage (e.g., VDD), and a drain terminal coupled to the first node (n1). In an alternative embodiment of FIGS. 8 and 9, the voltage-to-current generating circuit 110 may cascode another PMOS transistor (not shown) with transistor P1a. In such embodiments, the drain terminal of transistor P1a may be coupled to a source terminal of the cascoded transistor, and the drain terminal of the cascoded transistor may be coupled to the first node (n1). In the particular embodiment shown in FIG. 8, the gate terminal of PMOS transistor P1a is coupled to the second node (n2) and to an input of amplifier circuit 130. In the particular embodiment shown in FIG. 9, the gate terminal of PMOS transistor P1a is coupled to an output of amplifier circuit 130 and to the gate terminals of the PMOS transistors (P1 . . . PN) in the output branches 140.

The integrate and hold circuit 120 shown in FIGS. 8-9 includes a capacitor (Chola), which is coupled between the supply voltage and the second node (n2). When switches S1 and S2 are closed, reference current source 150 supplies a reference current (I_{ref}) to the bias current generator circuit 100, which induces a feedback current (I_{fb}) through the source-to-drain path of PMOS transistor P1a. The reference and feedback currents are subtracted at the first node (n1), and a difference between the two currents (ΔI=I_{fb}−I_{ref}) is integrated across the capacitor (C_{hold}) to generate a first voltage (V₁) at the second node (n2). The first voltage (V₁) is applied to a (non-inverting) input of amplifier circuit 130 for generating a second voltage (V₂), which is substantially equal to the first voltage. In the embodiment of FIG. 8, the first voltage (V₁) is fed back to the gate terminal of PMOS transistor P1a. In the embodiment of FIG. 9, however, the gate terminal of PMOS transistor P1a is coupled to receive the second voltage (V₂). In either embodiment, the feedback loop becomes stable when I_{fb}=I_{ref}.

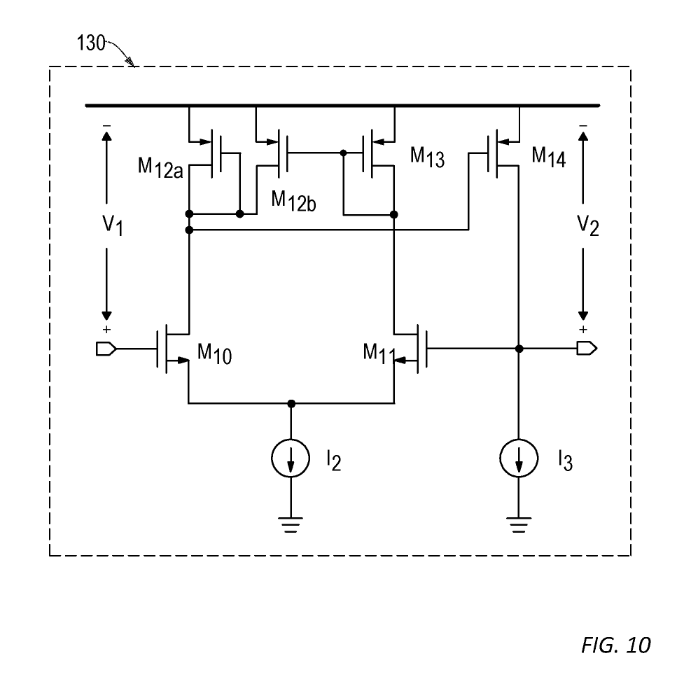

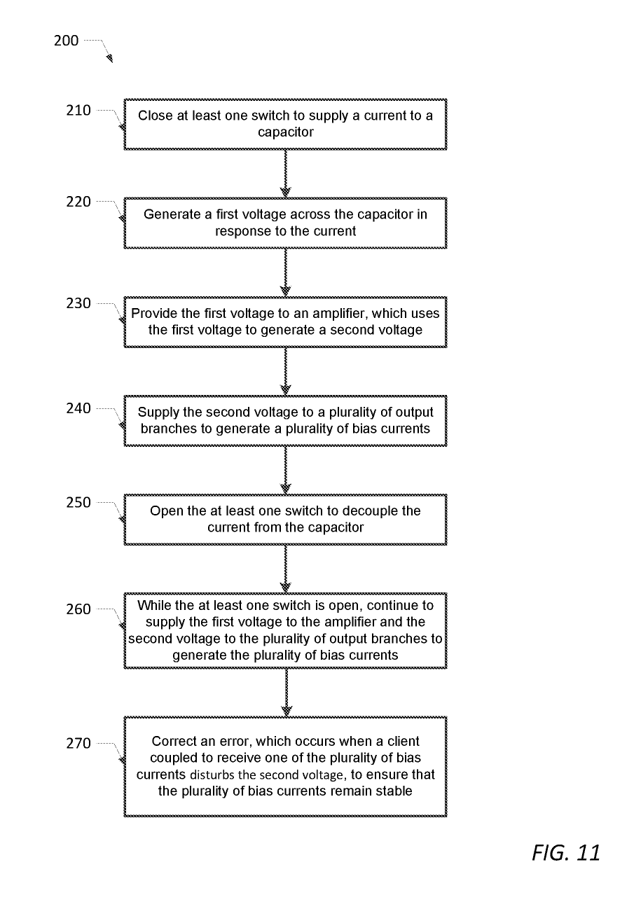

In the embodiments of FIGS. 8 and 9, amplifier circuit 130 is a differential amplifier having a non-inverting input coupled to the second node (n2), and an inverting input tied to its output at node (n3), so the voltage gain of the amplifier circuit will be close to unity. As such, differential amplifier circuit 130 may otherwise be referred to as a unity gain amplifier, a buffer amplifier (or simply “buffer”), an isolation amplifier or a voltage follower. In FIGS. 8 and 9, the amplifier circuit output (i.e., the second voltage, V₂, generated at node n3) is coupled to drive the gate terminals of the PMOS transistors (P1 . . . PN) in the output branches 140. As noted above, substantially any number (N) of PMOS transistors may be included within the output branches 140 for generating the same number (N) of bias currents (I_{b1 . . . bN}). The differential amplifier circuit 130 shown in FIGS. 8-9 may be implemented in a variety of different ways, one of which is shown in FIG. 10 and described in more detail below.

FIG. 10 is a circuit diagram illustrating one example of a differential amplifier circuit 130 that may be included within the bias current generator circuits 100 shown in FIGS. 8 and 9. As noted above, the differential amplifier circuit 130 included within the embodiments of FIGS. 8 and 9 is a unity gain amplifier, or a voltage buffer having a voltage gain of 1, which is configured to generate a second voltage (V₂) substantially equal to the first voltage (V₁). Although one example of a unity gain amplifier is shown in FIG. 10 and described in more detail below, the amplifier circuit 130 shown generically in FIGS. 8 and 9 is not strictly limited to the implementation shown in FIG. 10, and may be implemented differently in other embodiments.

In the example shown in FIG. 10, differential amplifier circuit 130 illustrates one example of a unity gain voltage buffer that may be used to isolate the input of the buffer from the output. V₁ and V₂ are the input and the output of the voltage buffer, respectively. NMOS transistors M₁₀ and M₁₁ are connected to sense the voltage difference between the input and the output of the buffer circuit 130, and to convert the voltage signal into a difference in the drain currents corresponding to M₁₀ and M₁₁. PMOS transistors M₁₃ and M_{12b} are used as a current mirror to mirror the drain current of M₁₁ to the drain terminal of M₁₀. In order to minimize an offset voltage associated with the amplifier circuit 130, NMOS transistors M₁₀ and M₁₁ should have the same length and width, and PMOS transistors M₁₃, M₁₂ₐ and M_{12b} should have the same length, while the sum of the total widths of M₁₂ₐ and M_{12b} should be equal to the width of M₁₃.

The differential amplifier 130 is implemented in two stages to achieve high open loop gain and to minimize the dc error between the output (V₂) and the input (V₁) of the amplifier circuit. Current source I₂ is used to bias the first stage, while current source I₃ is used to bias the second stage of the amplifier circuit. PMOS transistor M₁₄, which is included within the second stage of the amplifier circuit 130, acts a common-source amplifier with high output resistance. Since amplifier circuit 130 is load compensated, the first stage gain is controlled by the ratio between M₁₂ₐ and M_{12b} and chosen to push the non-dominant pole to high frequencies. In one example, the width of M_{12b} may be approximately double the width of M₁₂ₐ, so that the first stage gain (A₁) may be approximately equal to −5/6×(gₘ₁₁/gₘ₁₂ₐ)=−5/2×(gₘ₁₁/gₘ₁₃). The gain (A₂) of the second stage of the amplifier circuit 130 may be very high, due to the high output resistance of PMOS transistor M₁₄. In one example, the second stage gain may be A₂=−gₘ₁₄×(r_{ds14}∥R_{I3}) where R_{I3} is the output resistance of I₃. Due to the negative feedback of the output, Vₒᵤₜ/Vᵢₙ=V₂/V₁=1/(1+A₁A₂)≈1, since the dc loop gain (A₁×A₂) of the amplifier circuit 130 is relatively high.

Like the previous embodiments shown in FIGS. 6 and 7, the amplifier circuit 130 shown in FIGS. 8 and 9 isolates the first voltage (V₁) generated across the capacitor C_{hold} from the second voltage (V₂) used to drive the output branches 140. When one of the connected clients turns its bias current OFF/ON (or disturbs the output node voltage for any other reason), a corresponding one of the PMOS transistors (P1 . . . PN) in output branches 140 will introduce a voltage change (e.g., ΔV_{kickback}) at node n3. However, amplifier circuit 130 compensates for this voltage change by forcing the second voltage (V₂) to return back to its value before the kickback occurred, which may be substantially equal to the voltage held across capacitor C_{hold}. By isolating the first voltage (V₁) from the second voltage (V₂), the amplifier circuit 130 shown in FIGS. 8 and 9 prevents or significantly inhibits voltage kickback from affecting the first voltage when one (or more) of the connected clients turns its bias current OFF/ON (or disturbs the output node voltage for any other reason) and ensures that stable bias currents (I_{b1 . . . bN}) are generated in all output branches 140. Like the previous embodiments shown in FIGS. 6 and 7, the amplifier circuit 130 shown in FIGS. 8 and 9 generates stable bias currents, regardless of client operating state.

As set forth above, FIGS. 6-9 illustrate various embodiments of bias current generator circuits 100 in accordance with the present disclosure. In some embodiments, the bias current generator circuit 100 shown in FIGS. 6 and 7 may be preferred, due to the simplicity and small area consumption of the single-ended amplifier circuit 130 design. In other embodiments, the bias current generator circuit 100 shown in FIGS. 8-9 may be preferred, since the unity gain amplifier circuit 130 used in these embodiments may consume less current than the single-ended amplifier circuit 130 shown in FIGS. 6-7, and can be implemented with a general purpose amplifier configured in unity feedback configuration. However, each of the amplifier circuits 130 shown in FIGS. 6-8 may introduce an offset into the second voltage (V₂), which is not compensated for in the embodiments shown in FIGS. 6-8. Although the absolute value of the offset may be relatively small (e.g., 1-100 mV), the amplifier offset voltage will affect the bias currents (I_{b1 . . . bN}) generated in output branches 140. To overcome this problem, the embodiment shown in FIG. 9 may be used.

In the embodiment shown in FIG. 9, the output of amplifier circuit 130 (rather than the input of the amplifier circuit) is fed back to the gate terminal of PMOS transistor P1a for generating the feedback current (I_{fb}). In this case, the feedback loop consisting of PMOS transistor P1a and amplifier circuit 130 forces the voltage (V₂) generated at the output, node n3, of the amplifier circuit to correspond to an output current (I_{fb}), which is equal to the reference current (Iᵣₑf), regardless of the amplifier offset voltage. Thus, the bias current generator circuit shown in FIG. 9 may be preferred when accuracy is a concern.

FIG. 11 is a flow chart diagram illustrating one embodiment of a method 200 for generating stable bias currents in a bias current generator including at least one switch, a capacitor, an amplifier circuit and a plurality of output branches. Although not strictly limited to such, method 200 may be performed by any of the bias current generator circuits 100 shown in FIGS. 3 and 6-9 and discussed above.

In some embodiments, method 200 may begin in step 210 by closing the at least one switch to supply a current to the capacitor. While the at least one switch is closed, the method may generate a first voltage (V₁) across the capacitor in response to the current in step 220, provide the first voltage to the amplifier circuit, which uses the first voltage to generate a second voltage (V₂), in step 230, and supply the second voltage to the plurality of output branches to generate a plurality of bias currents (I_{b1 . . . bn}) in step 240.

In step 250, the at least one switch may be opened to decouple the current from the capacitor, thereby reducing current consumption in the bias current generator circuit. While the at least one switch is open, the method may continue to supply the first voltage to the amplifier circuit and the second voltage to the plurality of output branches to generate the plurality of bias currents in step 260. In some cases, a client connected to one of the plurality of output branches may turn its bias current OFF/ON, and in doing so, may create a voltage disturbance at the output branch, which causes an error to be generated in the second voltage. In step 270, the method may correct or compensate for such error to ensure that the plurality of bias currents remain stable (I_{b1 . . . bn}). In one embodiment, the amplifier circuit may correct the error in the second voltage by forcing the second voltage to be proportional to the first voltage. In another embodiment, the amplifier circuit may correct the error in the second voltage by forcing the second voltage to return back to its value before the disturbance occurred.

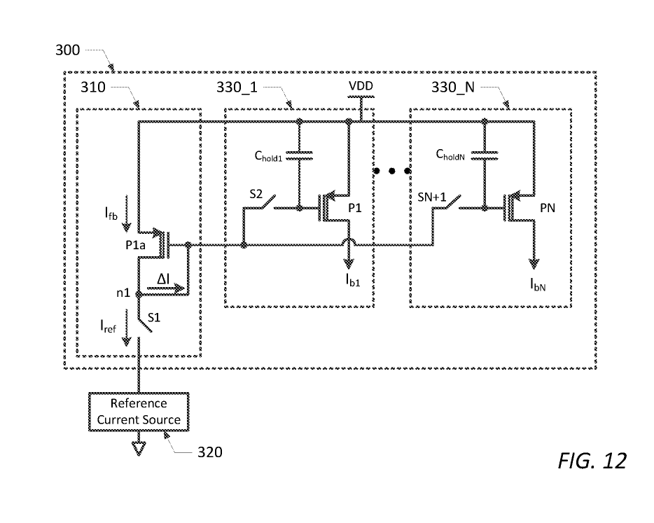

FIG. 12 is a circuit diagram illustrating a bias current generator circuit 300 according to another embodiment of the present disclosure. Unlike the embodiments shown in FIGS. 6-9, bias current generator circuit 300 does not include an amplifier circuit for isolating the second voltage (V₂) from the first voltage (V₁). Instead of correcting voltage errors that occur when a client coupled to receive one of the bias currents turns its respective bias current OFF/ON, the embodiment shown in FIG. 12 isolates the output branches from one another, thereby preventing a voltage error generated in one output branch from affecting the other output branches.

As shown in FIG. 12, bias current generator circuit 300 is implemented with a current mirror architecture. Bias current generator circuit 300 includes a current mirror input branch 310 coupled to receive a reference current (I_{ref}) from a reference current source 320, and a plurality of current mirror output branches 330_1 . . . 330_N coupled in a current mirror configuration to the current mirror input branch 310. Although substantially any reference current source 320 may be used (such as, e.g., a resistor, a voltage divider network, a current mirror, etc.), bias current generator circuit 300 may be coupled, in some embodiments, to receive a reference current from one of reference current sources shown in FIGS. 4-5 and discussed above.

In the embodiment shown in FIG. 12, current mirror input branch 310 includes a diode-connected PMOS transistor (P1a), which is coupled to generate a feedback current (I_{fb}) equal to the reference current (I_{ref}) when a switch (S1) is closed. The plurality of current mirror output branches 330_1 . . . 330_N are configured to generate a plurality of bias currents (I_{b1 . . . bn}), which are substantially equal to the feedback current (I_{fb}). Unlike the conventional current mirror circuit 10 shown in FIG. 1, each of the current mirror output branches 330_1 . . . 330_N shown in FIG. 12 includes a PMOS transistor (P1 . . . PN) coupled between a supply voltage (e.g., VDD) and an output of the bias current generator circuit, and a capacitor (C_{hold1} . . . C_{holdN}) coupled in parallel with the PMOS transistor between the supply voltage and a gate terminal of the PMOS transistor. Each current mirror output branch 330_1 . . . 330_N also include a switch (S2 . . . SN+1), which is coupled between the gate terminal of the diode-connected PMOS transistor P3 in the current mirror input branch 310 and the gate terminal of a PMOS transistor in a respective current mirror output branch 330_1 . . . 330_N.

Although the bias current generator circuit 300 shown in FIG. 12 appears similar to the conventional current mirror circuit shown in FIG. 1, output branch isolation is provided in bias current generator circuit 300 by including a separate capacitor (C_{hold1} . . . C_{holdN}) and a separate switch (S2 . . . SN+1) for each of the PMOS transistors (P1 . . . PN) included within the current mirror output branches 330_1 . . . 330_N. When a bias current is turned OFF/ON by a client coupled to one of the current mirror output branches 330_1 . . . 330_N, the gate-to-drain capacitance (C_{gd}) of the affected output transistor (e.g., transistor P1) will suffer a voltage change of ΔVₒᵤₜ. As noted above, this voltage change will introduce an error of ΔVₒᵤₜ*C_{gd}/C_{hold1} (i.e., a kickback voltage, V_{kickback}) in the voltage developed across the capacitor (C_{hold1}), which in turn, introduces an error in the bias current (I_{b1}) generated in that output branch (see, EQ. 1). Unlike the conventional current mirror circuit 10 shown in FIG. 1, however, the kickback voltage generated across the capacitor (C_{hold1}) in the affected output branch is isolated from the PMOS transistors in the remaining output branches in the embodiment of FIG. 12. In this manner, the kickback voltage generated in one current mirror output branch will not affect the bias currents generated in the remaining current mirror output branches in FIG. 12. This enables the remaining current mirror output branches to continue to generate stable bias currents.

It will be appreciated to those skilled in the art having the benefit of this disclosure that this disclosure is believed to provide various embodiments of bias current generator circuits that do not suffer from the effects of voltage kickback. Further modifications and alternative embodiments of various aspects of the disclosure will be apparent to those skilled in the art in view of this description. It is to be understood that the various embodiments of the disclosed bias current generator circuits shown and described herein are to be taken as the presently preferred embodiments. Elements and materials may be substituted for those illustrated and described herein, parts and processes may be reversed, and certain features of the disclosed embodiments may be utilized independently, all as would be apparent to one skilled in the art after having the benefit of this disclosure. It is intended, therefore, that the following claims be interpreted to embrace all such modifications and changes and, accordingly, the specification and drawings are to be regarded in an illustrative rather than a restrictive sense.

What is claimed is:

1. A bias current generator circuit coupled to receive a reference current from a reference current source, the bias current generator circuit comprising:
a voltage-to-current generating circuit coupled to supply a first current to a first node of the bias current generator circuit;
an integrate and hold circuit coupled to the first node for receiving a second current, which is equal to a difference between the first current and the reference current, wherein the integrate and hold circuit is configured to generate a first voltage in response to the second current;
an amplifier circuit coupled to receive the first voltage generated by the integrate and hold circuit, wherein the amplifier circuit is configured to generate a second voltage in response to the first voltage; and
a plurality of output branches coupled to receive the second voltage from the amplifier circuit and configured to generate a plurality of bias currents in response thereto.

2. The bias generator circuit recited in claim 1, further comprising a first switch coupled between the reference current source and the first node for connecting and disconnecting the reference current source to and from the first node.

3. The bias generator circuit recited in claim 1, further comprising a second switch coupled between the first node and a second node of the bias current generator circuit, wherein the second node is coupled to an input of the amplifier circuit.

4. The bias generator circuit recited in claim 3, wherein when the second switch is closed and the reference current source is connected to the bias current generator circuit for supplying the reference current to the first node, the first node is connected to the second node for supplying the second current to the integrate and hold circuit, which uses the second current to generate the first voltage.

5. The bias generator circuit recited in claim 3, wherein when the second switch is opened and the reference current source is disabled or disconnected from the bias current generator circuit, the first node is disconnected from the second node, and the first voltage generated by the integrate and hold circuit is supplied to the input of the amplifier circuit for generating the second voltage.

6. The bias generator circuit recited in claim 3, wherein the voltage-to-current generating circuit comprises a first n-channel Metal Oxide Semiconductor (NMOS) transistor having a drain terminal coupled to the first node, a source terminal coupled to a ground potential, and a gate terminal coupled to the second node and to the input of the amplifier circuit.

7. The bias generator circuit recited in claim 6, wherein the integrate and hold circuit comprises a capacitor, which is coupled in parallel with the first NMOS transistor between the second node and the ground potential, and wherein the first voltage is generated across the capacitor in response to the second current.

8. The bias generator circuit recited in claim 6, wherein the amplifier circuit is a single-ended amplifier comprising a first p-channel MOS (PMOS) transistor in series with a second NMOS transistor between a supply voltage and the ground potential, wherein a gate terminal of the second NMOS transistor is coupled to the second node and the gate terminal of the first NMOS transistor, and wherein a gate terminal of the first PMOS transistor is coupled to a drain terminal of the first PMOS transistor.

9. The bias generator circuit recited in claim 8, wherein the plurality of output branches comprise a plurality of PMOS transistors, each having a source terminal coupled to the supply voltage and a gate terminal coupled to the gate terminal of the first PMOS transistor.

10. The bias generator circuit recited in claim 3, wherein the voltage-to-current generating circuit comprises a first PMOS transistor having a source terminal coupled to a supply voltage, and a drain terminal coupled to the first node.

11. The bias generator circuit recited in claim 10, wherein the integrate and hold circuit comprises a capacitor, which is coupled between the supply voltage and the second node, and wherein the first voltage is generated across the capacitor in response to the second current.

12. The bias generator circuit recited in claim 10, wherein a gate terminal of the first PMOS transistor is coupled to the second node.

13. The bias generator circuit recited in claim 10, wherein the amplifier circuit is a unity gain amplifier having a first input coupled to the second node.

14. The bias generator circuit recited in claim 10, wherein the plurality of output branches comprise a plurality of PMOS transistors, each having a source terminal coupled to the supply voltage and a gate terminal coupled to an output of the amplifier circuit.

15. The bias generator circuit recited in claim 14, wherein a gate terminal of the first PMOS transistor is coupled to the output of the amplifier circuit and to the gate terminals of the plurality of PMOS transistors.

16. A method for generating bias currents in a bias current generator including at least one switch, a capacitor, an amplifier circuit and a plurality of output branches, the method comprising:
closing the at least one switch to supply a current to the capacitor, to supply a first voltage to the amplifier circuit, and to supply a second voltage to the plurality of output branches to generate a plurality of bias currents; and
opening the at least one switch to decouple the current from the capacitor, wherein while the at least one switch is open, the method further comprises:
continuing to supply the first voltage to the amplifier circuit and the second voltage to the plurality of output branches to generate the plurality of bias currents; and
correcting an error, which occurs when a client coupled to receive one of the plurality of bias currents disturbs the second voltage, to ensure that the plurality of bias currents remain stable.

17. The method as recited in claim 16, wherein while the at least one switch is closed, the method further comprises:
generating the first voltage across the capacitor in response to the current;
providing the first voltage to the amplifier circuit, which uses the first voltage to generate the second voltage; and
supplying the second voltage to the plurality of output branches to generate the plurality of bias currents.

18. The method as recited in claim 16, wherein the step of correcting an error comprises forcing the second voltage to be proportional to the first voltage via the amplifier circuit.

19. The method as recited in claim 16, wherein the step of correcting an error comprises forcing the second voltage to return back to a previous value of the second voltage before the second voltage was disturbed by the client.

20. A bias current generator circuit coupled to receive a reference current from a reference current source at a first node, the bias current generator circuit comprising:
a current mirror input branch coupled to receive the reference current, wherein the current mirror input branch comprises a diode-connected transistor, which is configured to generate a feedback current equal to the reference current;
a plurality of current mirror output branches coupled to the current mirror input branch and configured to generate a plurality of bias currents substantially equal to the feedback current, wherein the plurality of current mirror output branches each comprise:
a transistor coupled between a supply voltage and an output of the bias current generator circuit; and
a capacitor coupled in parallel with the transistor between the supply voltage and an input terminal of the transistor.

21. The bias current generator circuit as recited in claim 20, wherein the plurality of current mirror output branches each further comprise a switch, which is coupled between an input terminal of the diode-connected transistor in the current mirror input branch and the input terminal of the transistor in a respective current mirror output branch.
